(19) United States
(12) Patent Application Publication
(10) Pub. No.: US 2008/0019595 A1
(43) Pub. Date: Jan. 24, 2008

(54) System And Method For Identifying Patterns

(76) Inventor: KUMAR ESWARAN, Secunderabad (IN)

Correspondence Address: LAWRENCE Y.D. HO & ASSOCIATES PTE LTD, 30 BIDEFORD ROAD, #02-02, THONGSIA BUILDING, SINGAPORE, 229922, omitted

(21) Appl. No.: 11/779,890

(22) Filed: Jul. 19, 2007

(30) Foreign Application Priority Data
Jul. 20, 2006 (IN) 1256/CHE/2006

(51) Int. Cl. G06K 9/48

(52) U.S. Cl. 382/197

(57) ABSTRACT

The present invention relates to a system and method for identifying of a pattern by comparing the pattern with two or more identified patterns. The system comprises an input unit for capturing a pattern for identification, a processing unit for determining eigenfaces corresponding to the captured pattern and the two or more identified patterns, and determining orientation vectors corresponding to each determined eigenface, and a comparison unit for comparing the determined orientation vector corresponding to the captured pattern with each of the determined orientation vectors corresponding to the identified patterns. The method comprises determining eigenvectors corresponding to each of the identified patterns, determining eigenfaces corresponding to each of the identified patterns and the pattern being identified, determining orientation vectors corresponding to each of the identified patterns and the pattern being identified, comparing an orientation vector corresponding to the pattern being identified with each of the orientation vectors corresponding to the identified patterns, and identifying the pattern. The present invention further provides a method of clustering a plurality of patterns into a predetermined number of clusters by using orientation vectors.

### FIELD OF INVENTION

The present invention is directed towards identification of patterns. More particularly, the present invention provides a system and methods for identifying a pattern by determining comparable features of the pattern and comparing said features with determined comparable features of a plurality of patterns.

### BACKGROUND OF THE INVENTION

Pattern identification involves classifying observed or measured data into known categories using statistical or syntactic approaches. Applications of pattern recognition include biometrics such as fingerprint, iris, and facial image identification, weather forecasting by map analysis, character recognition, speech recognition, medical diagnostic data analysis, and bar code recognition.

Conventionally in a pattern identification system firstly an object being identified is represented as data that may be further processed. For example, for facial identification a facial image is captured as a photograph, and for speech recognition spoken words to be identified are input through a microphone. Next, feature extraction is carried out on the data in order to extract essential features that may be used for comparison of the object being identified with similar objects. Various criteria are used for classifying the object into known categories for identification. There is need for a classification criterion which enables classification and subsequent identification of patterns by using the extracted comparable features of the patterns.

Pattern identification also forms a basis for clustering of patterns. Clustering refers to dividing a group of patterns into subgroups based on a common characteristic shared by patterns within a sub group. For example, in case of facial identification if a total of t photographs are provided, of which d different photographs belong to n different people, a clustering method may be used to divide the t photographs into n sub groups such that each sub group comprises photographs of the same person.

Various conventional pattern identification schemes employ artificial neural networks (ANN) for pattern identification and clustering. Prior to automatically identifying input patterns, neural networks have to be trained to do so. During training the ANN is trained to associate output patterns with input patterns, so that when the ANN is used it identifies input patterns and tries to output the associated output pattern. When a pattern that has no output pattern associated with it is given as input to the ANN, the network produces an output pattern corresponding to a taught input pattern that is least different from the given input pattern. In this manner, an ANN can be taught to identify patterns via supervised or unsupervised learning methodologies. Since supervised learning methods require human intervention, they are considered cumbersome and are prone to human errors. There is need for efficient unsupervised learning methods for training ANN for use in applications involving pattern identification and clustering.

### SUMMARY OF THE INVENTION

A system for identification of a pattern by comparing the pattern with two or more identified patterns is provided. The system comprises an input unit for capturing a pattern for identification, a processing unit for determining eigenfaces corresponding to the captured pattern and the two or more identified patterns, and determining orientation vectors corresponding to each determined eigenface, an orientation vector representing orientation of a pattern with respect to every other pattern; and a comparison unit for comparing the determined orientation vector corresponding to the captured pattern with each of the determined orientation vectors corresponding to the identified patterns. The pattern may be one of an image or a sound signal or a medical diagnostic data from which comparable features may be extracted.

The system further comprises a repository for storing the two or more identified patterns that the captured pattern is compared with. The input unit is one of a camera or a scanner or an MRI device and the processing unit and the comparison unit are implemented as embedded systems. The comparison unit may be implemented as a neural network.

The present invention also provides a method for identification of a first pattern by comparing the first pattern with two or more identified patterns. The method comprises determining eigenvectors corresponding to each of the identified patterns. Secondly eigenfaces corresponding to each of the identified patterns and the first pattern are determined, an eigenface being determined by projecting a pattern on to a space created by at least two of the determined eigenvectors. Thirdly, orientation vectors corresponding to each of the identified patterns are determined, an orientation vector being determined by determining distances between an eigenface and every other eigenface. Fourthly, an orientation vector corresponding to the first pattern is determined, the orientation vector being determined by determining distances between the eigenface corresponding to the pattern being identified and every other eigenface corresponding to the identified patterns. Fifthly, an orientation vector corresponding the first pattern is compared with each of the orientation vectors corresponding to the identified patterns. The comparison comprises determining distances between the orientation vector corresponding to the first pattern and each of the orientation vectors corresponding to the identified patterns; and determining a least distance from among the determined distances. Lastly the pattern is identified as the identified pattern corresponding to the determined least distance.

The present invention also provides a method of clustering a plurality of patterns into a predetermined number of clusters. The method comprises determining orientation vectors corresponding to each of the plurality of patterns, the orientation vectors representing orientation of each pattern with respect to every other pattern. Secondly, one or more of the plurality of patterns are selected as seed points, the number of selected seed points being equal to the predetermined number of clusters. Thirdly, the predetermined number of clusters are formed by assigning each pattern to one of the selected seed points by using the determined orientation vectors, each pattern belonging to a cluster, the clusters being mutually exclusive. Fourthly, a feature of each of the formed clusters is selected to form new seed points. Fifthly, the predetermined number of new clusters are formed by reassigning each of pattern to one of the new seed points by using the determined orientation vectors, each pattern belonging to a new cluster, the new clusters being mutually exclusive. Lastly, steps fourth and fifth are repeated, if a pattern belongs to a new cluster which is different from the cluster to which the pattern belonged before the formation of the new cluster.

In an embodiment of the present invention, the step of forming the predetermined number of clusters by assigning each pattern to one of the selected seed points by using the determined orientation vectors comprises firstly determining Euclidean distances between orientation vectors of each pattern and orientation vectors of the selected seed points and secondly assigning each pattern to a seed point if the determined distance is less than a predetermined threshold value.

In an embodiment of the present invention, centroids of each of the formed clusters are selected as new seed points.

### BRIEF DESCRIPTION OF THE ACCOMPANYING DRAWINGS

The present invention is described by way of embodiments illustrated in the accompanying drawings wherein:

FIG. 1 illustrates a system for identification of a pattern with minimum false acceptance;

FIG. 2 illustrates a method for identification of a pattern with minimum false acceptance; and

FIG. 3 illustrates a method for clustering a plurality of patterns into a predetermined number of clusters by using orientation vectors.

### DETAILED DESCRIPTION OF THE INVENTION

A system and methods for identification of patterns are described herein. The present disclosure is more specifically directed towards identifying images such as facial images by comparing a captured image with a plurality of identified images stored in an image repository. However, the system and methods of the present invention may be used to identify any pattern from which comparable features may be extracted, as would be apparent to a person of ordinary skill in the art. For example, the present invention may be used in applications directed towards character recognition, speech recognition, medical diagnostic data analysis from blood samples, urine samples etc., for disease diagnostics and other applications.

The following disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been omitted or have not been described in detail so as not to unnecessarily obscure the present invention.

The present invention would now be discussed in context of embodiments as illustrated in the accompanying drawings.

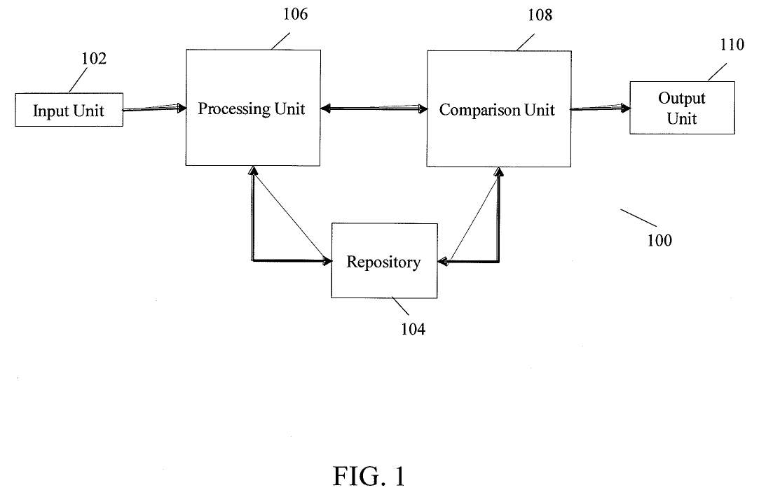

FIG. 1 illustrates a system for identification of a pattern. System 100 comprises an input unit 102, a repository 104, a processing unit 106, a comparison unit 108 and an output unit 110. Input unit 102 captures a pattern for identification. In an embodiment of the present invention, input unit 102 may be an image capturing device such as a camera, a scanner, or an MRI device etc. Input device 102 captures images in a digital format. In embodiments of the present invention, where input device 102 captures images in an analog format, an analog to digital converter is used to convert the captured images into a digital format before said images are fed to processing unit 106.

Repository 104 comprises two or more identified patterns stored in a digital format. In various embodiments of the present invention, repository 104 may be any of the commonly available databases. The patterns stored in repository 104 are termed as identified patterns since these patterns are used as reference for identifying any pattern captured by input unit 102.

Processing unit 106 processes the pattern captured by input unit 102 and the identified patterns stored in repository 104, and determines an eigenface and an orientation vector corresponding to each processed pattern. In an embodiment of the present invention, processing unit 106 is implemented as an embedded system comprising firmware. The firmware processes each of the captured patterns and the identified patterns, and determines an eigenface and an orientation vector corresponding to each processed pattern.

Comparison unit 108 compares the determined orientation vector corresponding to the captured pattern with each of the determined orientation vectors corresponding to the identified patterns. The comparison is carried out to obtain a least distance between the orientation vector corresponding to the captured pattern and an orientation vector corresponding to any of the identified patterns. The identified pattern corresponding to the least distance is termed as a match. The captured pattern is identified as the match. In an embodiment of the present invention, the orientation vector corresponding to the captured pattern and orientation vectors corresponding to the identified patterns are compared by obtaining Euclidean distances between the orientation vector corresponding to the captured pattern and each of the orientation vectors corresponding to the identified patterns.

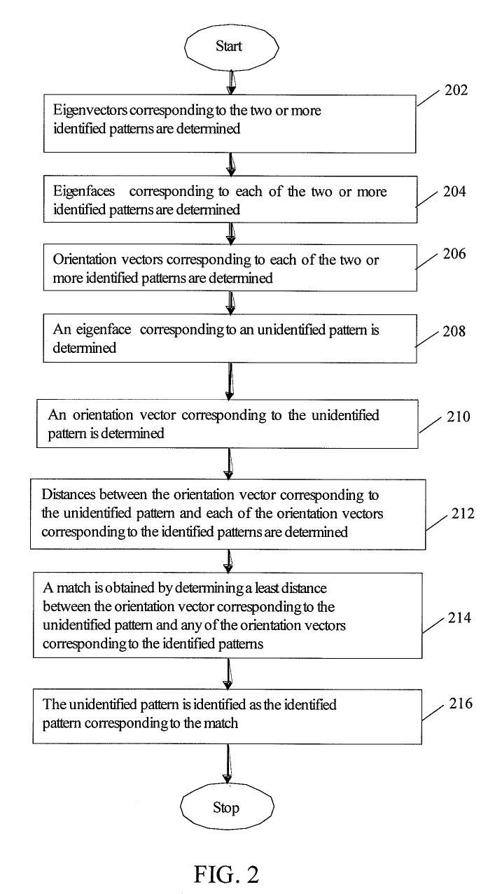

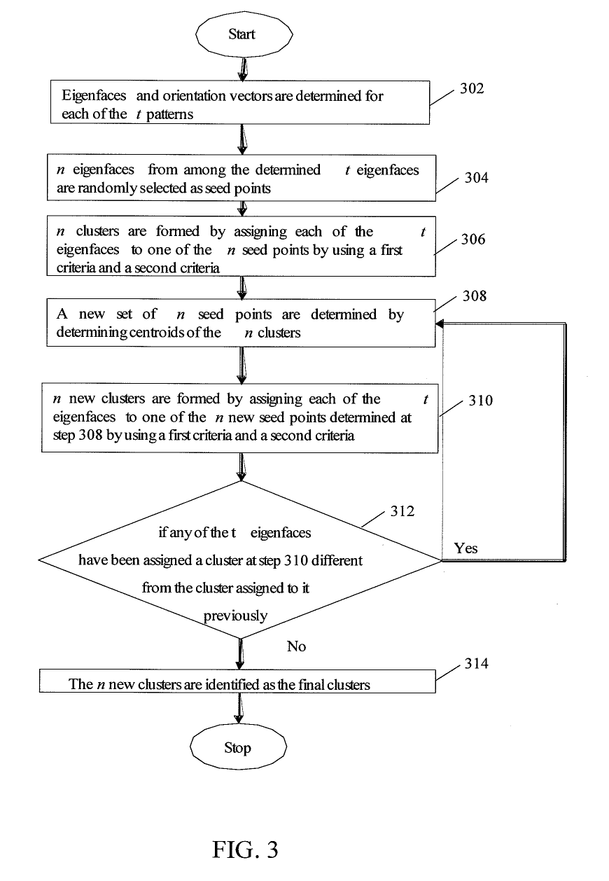

In an embodiment of the present invention, comparison unit 108 is implemented as an artificial neural network. The neural network is trained to identify input patterns by using orientation vectors of the patterns. The method employed for training said network for identifying patterns is described with reference to FIG. 2 and FIG. 3.

Output unit 110 displays one or both of the captured pattern and the match. In various embodiments of the present invention, the output unit 110 may be any of the commonly available output devices such as a screen or a printer.

FIG. 2 illustrates a method for identification of a pattern. The method disclosed in the present invention may be employed for identification of any pattern from which comparable features may be extracted by comparing the pattern with a plurality of known or previously identified patterns. Such comparable features comprise feature vectors. In an embodiment of the present invention, the unidentified and the identified patterns comprise images such as facial images. In other embodiments, the patterns may also comprise characters, speech signals or medical diagnostic data such as blood samples.

At step 202 eigenvectors corresponding to the two or more identified patterns are determined. In order to determine an eigenvector corresponding to a pattern a correlation vector corresponding to the pattern is required to be determined. For example, if there are N number of identified images, each being represented as m×n number of pixels, in order to obtain eigenvectors corresponding to the N images the steps that may be followed are:

Firstly, each image is represented as a column matrix to obtain N column matrices: A₁, A₂, A₃ . . . A_{N}.

### Secondly, a matrix A_{avg} is defined which represents an average of the N column matrices corresponding to the N images.

Thirdly, a matrix φⱼ is defined as:

φⱼ=Aⱼ−A_{avg.} (1)

where j=1,2 . . . N

### Next a matrix B is defined as B=[φ₁, φ₂, φ₃, . . . φ_{N}], the size of matrix B being mn×N

Next a correlation matrix is determined. A correlation matrix is defined as:

$$C = \frac{1}{N - 1} {BB}^{T} \qquad ( 2 )$$

where B^{T} is a transpose matrix of the matrix B.
However, obtaining correlation matrix using equation 2 results in a matrix of size mn×nm which matrix may be difficult to process due to its large size. Therefore a matrix D is determined as:

$$D = \frac{1}{N - 1} {B}^{T} B \qquad ( 3 )$$

The size of matrix D is N×N which may be processed more easily than matrix C. The eigenvalues of D are denoted as:

DV=λV (4)

where λ is an eigenvalue and V is a unit matrix.
i.e

$$D = \frac{1}{N - 1} {B}^{T} {BV}_{-} = λ {V}_{-} \qquad ( 5 )$$

Multiplying both sides of equation 5 by B we obtain:

$$\frac{1}{N - 1} ( {BB}^{T} ) {BV}_{-} = λ ( {BV}_{-} ) \qquad ( 6 )$$

### Therefore BV is the eigenvector of the correlation matrix

$$\frac{1}{N - 1} {BB}^{T} .$$

### Since, BV is a column matrix of size mn, it may also be termed as an “eigen image” corresponding to eigenvalue λ. Hence, the largest N eigenvalues of C are the eigenvalues of D. If,

E=BV (7)

then the N eigenvectors corresponding to the N identified images may be denoted by E₁, E₂, E₃, E₄ . . . E_{N}.

At step 204 eigenfaces corresponding to each of the two or more identified patterns are determined. For example, for the N number of identified images, a face-space is created using the corresponding eigenvectors E₁, E₂, E₃, E₄ . . . E_{N} and each of the images is projected onto the face-space to obtain eigenfaces corresponding to each of them. The face-space is a space spanned by these eigenvectors. In an embodiment of the present invention, only K eigenvectors whose eigenvalues have values larger than a predetermined threshold value may be used to determine the face-space, where K≦N. K may be used to reduce dimensions of the face-space created. In other embodiments of the present invention, K may also be equal to N. Hence, for an image φ₁ a corresponding eigenface W₁ is denoted as:

$$\begin{matrix}{\underline{W}}_{1} = ( {w}_{11} , {w}_{12} , {w}_{13} … {w}_{1 K} ) \\ \text{where:} & ( 8 ) \\ {w}_{11} = {\sum }_{j = 1}^{N} {φ}_{1} [ j ] {E}_{- 1} [ j ] & ( 9 ) \\ {w}_{12} = {\sum }_{j = 1}^{N} {φ}_{1} [ j ] {E}_{- 2} [ j ] \\ … & ( 10 ) \\ {w}_{1 K} = {\sum }_{j = 1}^{N} {φ}_{1} [ j ] {E}_{- K} [ j ] & ( 11 )\end{matrix}$$

Similarly N eigenfaces W₁, W₂, W₃, . . . W_{N} one for each of the N identified images are determined. For the purposes of the disclosure, the term “eigenface” generally refers to patterns including images or other data.

At step 206 orientation vectors corresponding to each of the two or more identified patterns are determined. An orientation vector corresponding to an identified pattern represents orientation of the pattern with respect to every other identified pattern in an n dimensional space; where n denotes a number of identified patterns. Orientation vector of an identified pattern is determined by determining Euclidean distances between the eigenface corresponding to the pattern and the eigenfaces corresponding to every other identified pattern. For example, for an eigenface corresponding to the s^{th} image, from among the N number of identified images, a corresponding orientation vector Os is denoted as:

Os=(ds₁,ds₂, . . . dsj . . . d_{SN}) (12)

where dsj is the Eucledian distance of the s^{th} eigenface from a j^{th} eigenface. Os is an N dimensional vector and represents the orientation of the s^{th} image with respect to all the other identified images in the N dimensional space.

At step 208 an eigenface corresponding to an unidentified pattern is determined. For example, for an unidentified image T a corresponding eigenface Tp is denoted as:

Tp=(T₁,T₂,T₃ . . . T_{K}) (13)

At step 210 an orientation vector corresponding to the unidentified pattern is determined. Orientation vector of the unidentified pattern is determined by determining Euclidean distances between the eigenface corresponding to the unidentified pattern and the eigenfaces corresponding to each of the N identified patterns. For example, for the unidentified image T a corresponding orientation vector O_{T} is denoted as:

O_{T}=(d_{T1},d_{T2}, . . . d_{Tj} . . . d_{TN}) (14)

where d_{Tj} is the Eucledian distance of the eigenface T from the j^{th} eigenface.

At step 212 distances between the orientation vector corresponding to the unidentified pattern and each of the orientation vectors corresponding to the identified patters are determined. In an embodiment of the present invention, the distances determined may be Euclidean distances. For example, with respect to the unidentified image T and the identified images N, an Euclidean distance between the orientation vector O_{T} and the orientation vector Os corresponding to the S^{th} identified image, is denoted by D_{TS} which is expressed as:

D_{TS}=/\sqrt{(d_{T1}−d_{S1})²+(d_{T2}−d_{S2})²+ . . . +(d_{TN}−d_{SN})²} (15)

At step 214 a match is obtained by determining a least distance between the orientation vector corresponding to the unidentified pattern and any of the orientation vectors corresponding to the identified patterns. The match is the identified pattern corresponding to the orientation vector which is at a least distance from an orientation vector corresponding to any of the unidentified patterns.

At step 216 the unidentified pattern is identified as the pattern corresponding to the match. For example, with respect to the unidentified image T and the N identified images, a μ^{th} identified image is denoted as a match if distance between the orientation vector corresponding to the unidentified image T (O_{T}) and an orientation vector Oμ corresponding to the μ^{th} identified image is determined to be the least, i.e., if:

D_{T}μ<=D_{TS}, for all s=1,2,3, . . . ,μ, . . . N (16)

In an embodiment of the present invention, prior to determining a match using orientation vectors, a match may be determined using any of the methods known in the art. The determined match may then be validated by using orientation vectors as described in the preceding sections. For example, with respect to the unidentified image T and the N identified images, a match may be determined by determining Euclidean distances between the eigenface corresponding to image T and each of the eigenfaces corresponding to the N identified images, prior to determining a match using orientation vectors. The Euclidean distance between the eigenfaces corresponding to the unidentified image T and the j^{th} identified image may be denoted as:

dⱼ=\sqrt{(wⱼ₁−T₁)²+(wⱼ₂−T₂)²+ . . . +(wⱼₖ−Tₖ)²} (17)

where wⱼ₁ is the first coordinate of the eigenface belonging to the j^{th} identified image. The match is an identified image μ such that d_{μ} is the smallest number in a set S={d₁, d₂, . . . d_{N}}. Therefore, the match is an image from among all the identified images, the eigenface of which image is at a least distance from the eigenface of the unidentified image. The obtained match may then be validated by determining a match by using orientation vectors, in order to obtain a match with a high degree of accuracy.

The present invention also provides a method for clustering a plurality of patterns into a predetermined number of clusters by using orientation vectors. Clustering refers to dividing a group of patterns into subgroups based on a common characteristic shared by patterns within a sub group. For example, if d different images belonging to n entities, i.e. a total of t=nd images, are provided, orientation vectors may be used to cluster the t images into n different classes corresponding to the n entities.

FIG. 3 illustrates a method for clustering a plurality of patterns into a predetermined number of clusters by using orientation vectors. At step 302 eigenfaces and orientation vectors are determined for each of the plurality of patterns. For example, if there are t number of patterns, an eigenface and an orientation vector is determined for each of the t patterns by using the method described with reference to FIG. 2.

At step 304 n eigenfaces from among the determined t eigenfaces are randomly selected as seed points. In an embodiment of the present invention, the seed points are selected by using a random number generator and are normalized to unity after selection.

In an embodiment of the present invention, orientation vectors corresponding to the selected seed points may be determined by determining orientation of a seed point with respect to each of the other selected seed points.

At step 306 n clusters are formed by assigning each of the t eigenfaces to one of the n seed points by using a first criteria and a second criteria, the second criteria being based on the determined orientation vectors. In an embodiment of the present invention, if there is a conflict between the results obtained by using the two criteria, the n clusters are formed by assigning each of the t eigenfaces to one of the n seed points by using the first criteria or the second criteria.

In an embodiment of the present invention, the first criteria is based on determination of Euclidean distances. For example, a pattern p from among the t patterns is assigned to a seed point nₐ if the Euclidean distance between the eigenface corresponding to p and the eigenface corresponding to nₐ is less than a predetermined threshold value τ. In an embodiment of the invention if a pattern may be assigned to any of a plurality of seed points, by using the first criterion, it is randomly assigned to any one of those seed points.

The second criterion uses the determined orientation vectors. For example, the pattern p from among the t patterns is assigned to the seed point nₐ if the Euclidean distance between the orientation vector corresponding to p and the orientation vector corresponding to nₐ is less than a predetermined threshold value ν. In an embodiment of the present invention the pattern p is assigned to the seed point nₐ if both the first criterion and the second criterion are met. In case there is a conflict between results obtained by using the two criteria, the pattern p is assigned to the seed point obtained by using the second criterion. Hence, n clusters are formed corresponding to each of the n seed points and, each of the t eigenfaces is grouped in one of the n clusters. In an embodiment of the invention if a pattern may be assigned to any of a plurality of seed points by using the second criterion i.e. the said pattern is of “equal distance” to each of these plurality of seed points, which would be a rare occurrence, it is randomly assigned to any one of those seed points.

In an embodiment of the present invention, the threshold values τ and ν are determined by using a random number generator. In another embodiment of the present invention, the threshold values τ and ν are determined by firstly determining mean values of the Euclidean distances between each of the t eigenfaces (a_{avg}) and the t orientation vectors respectively (b_{avg}). The preliminary value of τ may be chosen as 0.1 times a_{avg} and that of ν as 0.1 times b_{avg}. The obtained threshold values may be reduced based on the number and features of the patterns being clustered.

At step 308 a new set of n seed points are determined by determining centroids of the n clusters formed at step 306. The centroids are determined using any of the methods known in the art. Each determined centroid corresponds to an eigenface from among the t eigenfaces. These eigenfaces corresponding to the determined centroids form the new seed points.

At step 310 n new clusters are formed by assigning each of the t eigenfaces to one of the n new seed points determined at step 308 by using the first criteria and the second criteria, as described at step 306. Hence, each of the t eigenfaces is grouped in the n new clusters.

At step 312 a check is made to determine if any of the t eigenfaces have been assigned a cluster at step 310 different from the cluster assigned to it at step 306. If any of the t eigenfaces have been assigned a cluster at step 310 different from the cluster assigned to it at step 306, steps 308 to 312 are repeated. If none of the t eigenfaces have been assigned a cluster at step 310 different from the cluster assigned to it at step 306 or at the immediately preceding iteration, the clusters are identified as the final clusters at step 314. For example, for the t=nd images, the final clusters would correspond to n clusters of d images each, such that each of the d images in a cluster belong to the same entity.

In an embodiment of the present invention, the clustering method described with reference to FIG. 3 is used as a method of unsupervised learning for training a neural network. The trained neural network may be employed to automatically form a predetermined number of clusters from any given set of patterns.

The use of orientation vectors for pattern identification and clustering as described provides a high degree of accuracy, as is illustrated by the following example:

Assuming Euclidean distances of a point P from n number of other points labeled as 0, 1, 2, . . . ,(n−1) are denoted by r₀, r₁, r₂, . . . , rₙ₋₁ respectively, the coordinates of point P in an n-dimensional space labeled as (x₁, x₂, x₃, . . . , xₙ) may be calculated using the expression:

$$\begin{matrix}{x}_{i} = {\sum }_{j = 1}^{n - 1} {C}_{ij} {d}_{j} \\ for ( i = 1 , 2 , … , n - 1 ) ; \\ and & ( 18 ) \\ {x}_{n} = \pm {[ {r}_{0}^{2} - {\sum }_{i = 1}^{n - 1} {( {\sum }_{j = 1}^{n - 1} {C}_{ij} {d}_{j} )}^{2} ]}^{1 / 2} \\ where & ( 19 ) \\ dj = \frac{1}{2} [ {\sum }_{i = 1}^{n - 1} {( {a}_{i}^{( j )} )}^{2} + {r}_{0}^{2} - {r}_{j}^{2} ] & ( 20 )\end{matrix}$$

and C is the inverse of an (n−1)×(n−1) matrix A with elements defined as:

Aₖᵢ=aᵢ^{(k)} (21)

It is also assumed that the coordinates of the points 0, 1, 2, . . . ,(n−1), are denoted by n−1 vectors: a⁽¹⁾, a⁽²⁾, . . . a^{(j)}, . . . , a⁽ⁿ⁻¹⁾. The xₙ axis is chosen as an axis perpendicular to a hyper-plane containing the points 0, 1, 2, . . . ,(n−1), so that the xₙ coordinates of all these points is zero. Hence, it is evident that the location of a point in an n dimensional space is uniquely determined if its distance from n+1 other points is known. Also, the above implies that the point P belonging to a cluster of points that are separable into L classes, may be classified uniquely into one of these classes if an orientation vector of P is known and if L>=n+1.

The system and methods of the present invention may be used in any application which provides for classification of patterns by comparing feature vectors of the patterns. The system and method described in the present invention may also be used in any artificial intelligence or statistical based pattern recognition applications.

The system and methods for identifying patterns as described are particularly well suited for applications involving identification of facial images, however, may be applied to other applications by performing minor modifications as would be apparent to a person of skill in the art. For example, the system and methods of the present invention may be used in applications such as medical diagnostics, speech recognition, speaker recognition, machine diagnostics, and image classification, analysis and clustering, etc.

While the exemplary embodiments of the present invention are described and illustrated herein, it will be appreciated that they are merely illustrative. It will be understood by those skilled in the art that various changes in form and detail may be made therein without departing from or offending the spirit and scope of the invention as defined by the appended claims.

We claim:

1. A system for identification of a pattern by comparing the pattern with two or more identified patterns, the system comprising:
an input unit for capturing a pattern for identification;
a processing unit for:
determining eigenfaces corresponding to the captured pattern and the two or more identified patterns; and
determining orientation vectors corresponding to each determined eigenface, an orientation vector representing orientation of a pattern with respect to every other pattern; and
a comparison unit for comparing the determined orientation vector corresponding to the captured pattern with each of the determined orientation vectors corresponding to the identified patterns.

2. The system as claimed in claim 1 further comprising a repository for storing the two or more identified patterns that the captured pattern is compared with.

3. The system as claimed in claim 1, wherein the pattern may be one of an image or a sound signal or a medical diagnostic data from which comparable features may be extracted.

4. The system as claimed in claim 1, wherein the input unit is one of a camera or a scanner or an MRI device.

5. The system as claimed in claim 1, wherein the processing unit and the comparison unit are implemented as embedded systems.

6. The system as claimed in claim 1, wherein the comparison unit is implemented as a neural network.

7. A method for identification of a pattern by comparing the first pattern with two or more identified patterns, the method comprising the steps of:
a. determining eigenvectors corresponding to each of the identified patterns;
b. determining eigenfaces corresponding to each of the identified patterns and the first pattern, an eigenface being determined by projecting a pattern on to a space created by at least two of the determined eigenvectors;
c. determining orientation vectors corresponding to each of the identified patterns, an orientation vector being determined by determining distances between an eigenface and every other eigenface;
d. determining an orientation vector corresponding to the first pattern, the orientation vector being determined by determining distances between the eigenface corresponding to the pattern being identified and every other eigenface corresponding to the identified patterns;
e. comparing an orientation vector corresponding to the first pattern with each of the orientation vectors corresponding to the identified patterns, the comparison comprising the steps of:
determining distances between the orientation vector corresponding to the first pattern and each of the orientation vectors corresponding to the identified patterns; and
determining a least distance from among the determined distances; and
f. identifying the first pattern as the identified pattern corresponding to the determined least distance.

8. The method as claimed in claim 7 wherein an orientation vector corresponding to an identified pattern is determined by determining Euclidean distances between the eigenface corresponding to the identified pattern and the eigenfaces corresponding to each of the other identified patterns.

9. The method as claimed in claim 7 wherein orientation vector corresponding to the first pattern is determined by determining Euclidean distances between the eigenface corresponding to the first pattern and the eigenfaces corresponding to each of the identified patterns.

10. The method as claimed in claim 7 wherein the step of comparing an orientation vector corresponding to the first pattern with each of the orientation vectors corresponding to the identified patterns comprises determining Euclidean distances between the orientation vector corresponding to the first pattern and each of the orientation vectors corresponding to the identified patterns.

11. The method as claimed in claim 7 wherein the pattern is one from which comparable features may be extracted.

12. The method as claimed in claim 7 wherein the pattern may be one of an image or a sound signal or a medical diagnostic data from which comparable features may be extracted.

13. A method of clustering a plurality of patterns into a predetermined number of clusters, the method comprising the steps of:
a. determining orientation vectors corresponding to each of the plurality of patterns, the orientation vectors representing orientation of each pattern with respect to every other pattern;
b. selecting one or more of the plurality of patterns as seed points, the number of selected seed points being equal to the predetermined number of clusters;
c. forming the predetermined number of clusters by assigning each pattern to one of the selected seed points by using the determined orientation vectors, each pattern belonging to a cluster, the clusters being mutually exclusive;
d. selecting a feature of each of the formed clusters to form new seed points;
e. forming the predetermined number of new clusters by reassigning each of pattern to one of the new seed points by using the determined orientation vectors, each pattern belonging to a new cluster, the new clusters being mutually exclusive; and
f. repeating steps d and e, if a pattern belongs to a new cluster which is different from the cluster to which the pattern belonged before the formation of the new cluster.

14. The method as claimed in claimed in claim 13 wherein eigenfaces of one or more of the plurality of patterns are randomly selected as seed points.

15. The method as claimed in claim 13 wherein the step of forming the predetermined number of clusters by assigning each pattern to one of the selected seed points by using the determined orientation vectors comprises:
a. determining Euclidean distances between orientation vectors of each pattern and orientation vectors of the selected seed points; and
b. assigning each pattern to a seed point if the determined distance is less than a predetermined threshold value.

16. The method of claim 10 wherein centroids of each of the formed clusters are selected as new seed points.

17. The method as claimed in claim 13 providing for unsupervised learning of neural networks.
